(19) United States
(12) Patent Application Publication
(10) Pub. No.: US 2012/0108448 A1
(43) Pub. Date: May 3, 2012

(54) SYSTEM AND METHOD FOR CURATING MASS SPECTRAL LIBRARIES

(75) Inventors: Frank E. Kuhlmann, Los Altos, CA (US); Heloise Logan, San Jose, CA (US); Steven M. Fischer, Hayward, CA (US); Xiangdong Don Li, Union City, CA (US)

(73) Assignee: Agilent Technologies, Inc.

(21) Appl. No.: 12/938,953

(22) Filed: Nov. 3, 2010

(51) Int. Cl. C40B 30/02; G06F 19/00

(52) U.S. Cl. 506/8; 702/23

(57) ABSTRACT

Systems and method for curation of mass spectral libraries. In general, the systems and methods provided herein (a) obtain an experimentally derived mass spectrum of a compound of interest; (b) identify a peak in the mass spectrum that represent an experimental m/z value for an ion fragment of the compound of interest; (c) remove from the mass spectrum any peak that does not correspond to the compound of interest; and (d) replace the experimental m/z value for the peak identified in step (b) with a calculated theoretical m/z value for the ion fragment.

### SUMMARY

Provided herein are systems and method for curation of mass spectral libraries. In general, the systems and methods provided herein (a) obtain an experimentally derived mass spectrum of a compound of interest; (b) identify a peak in the mass spectrum that represents an experimental m/z value for an ion fragment of the compound of interest; (c) remove from the mass spectrum any peak that does not correspond to the compound of interest; and (d) replace the experimental m/z value for the peak identified in step (b) with a calculated theoretical m/z value for the ion fragment.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a flowchart illustrating a method of curating a mass spectral library.

FIG. 2 is a flowchart illustrating a sub-protocol of the method of FIG. 1, in accordance with one embodiment presented herein.

FIG. 3A is a flowchart illustrating an alternative sub-protocol of the method of FIG. 1, in accordance with another embodiment presented herein.

FIG. 3B is a flowchart illustrating an alternative sub-protocol of the method of FIG. 1, in accordance with yet another embodiment presented herein.

FIG. 4 is a schematic illustration of a computer system for carrying out the methods described herein.

### DETAILED DESCRIPTION

The present invention generally relates to mass spectral analysis. More specifically, the present invention relates to systems and methods for curating mass spectral libraries.

In mass spectral libraries, inherent instrumentation error may result in the mass-to-charge (m/z) values for precursor ions and respective fragment ions being off from the theoretically expected values. Such instrumentation error results in loss of specificity and lower discrimination in scores of library searches.

Further, a library spectrum may contain peaks that do not originate from the analyzed compound of interest. Such peaks may instead represent chemical noise originating from other compounds isolated together with the compound of interest, or electronic noise. Such peaks will have a detrimental effect on search scores when searching unknown compounds. Ideally the library spectrum should only contain fragment ions derived from the compound of interest.

The systems and method provided herein allow for correcting the m/z values of the precursor ions and the fragment ions in a library spectrum. In practice, the experimentally derived m/z values is corrected to the theoretically expected values (i.e., theoretical values), using a systematic approach. In one embodiment, a molecular formula generation algorithm, in combination with knowledge of the target formula, is used to identify the m/z values to be corrected. Alternatively, a structural correlation algorithm (MSC) can be used to correct the m/z values. MSC attempts to correlate fragment ion m/z values with a known molecular structure using a systematic bond breaking approach and/or fragmentation rules.

When searching the spectrum of an unknown compound against the spectrum of a library compound with the m/z values corrected to the theoretical values, tighter tolerances can be used in the spectral matching algorithm, and the mass accuracy in the unknown spectrum can be exploited for higher specificity. Higher specificity results in fewer library search hits, and in higher discrimination in search scores.

The systems and methods provided herein also allow for the recognition and filtering of peaks in the library spectrum. In other words, peaks that do not originate from the compound of interest are removed from the library spectrum. As such, the systems and methods provided herein increase spectral matching scores for both forward and reverse searches, which results in higher specificity.

Correcting the m/z values to the theoretical values and/or the removal of fragment ions that do not originate from the compound of interest, represents a “curation” of the library spectra. The systematic approach described below allows for an automated curation of library spectra at very high throughput, which allows the efficient creation of accurate mass content libraries. The curation methods provided herein also improve the quality of library spectra by removing signal noise that may pass an initial stage of threshold noise filtering.

The following detailed description of the figures refers to the accompanying drawings that illustrate exemplary embodiments. Other embodiments are possible. Modifications may be made to the embodiments described herein without departing from the spirit and scope of the present invention. Therefore, the following detailed description is not meant to be limiting.

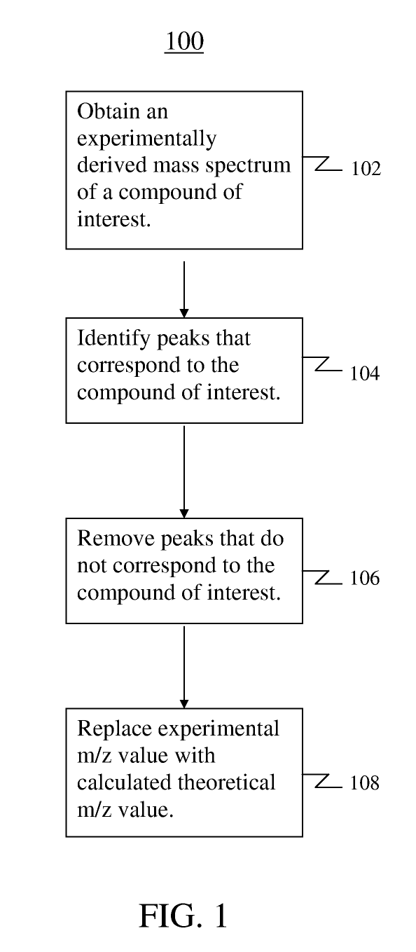

FIG. 1 is a flowchart illustrating a method 100 of curating a mass spectrum library. As used herein, the term “library” should be broadly interpreted to include any type of collection or database of mass spectra and/or mass content information. Method 100 may be performed on a computer system, whether or not the computer system is directly connected to an associated mass spectrometer (MS). In one embodiment, the curation method 100 is used to curate accurate mass MS/MS spectral libraries. Accurate mass libraries are defined as libraries with a mass precision of 200 ppm or less, or of 100 ppm or less, or of 50 ppm or less, or of 20 ppm or less, or of 10 ppm or less, or of 1 ppm or less. In various embodiments, such libraries may be obtained from Single Quadrupole (e.g., GC/MS EI libraries), Triple Quadrupole, Q-T of, orbital trapping mass spectrometers, magnetic-sector mass spectrometers, ion trap based instruments, or any other suitable mass spectrometers that are capable of making accurate mass measurements. Further, method 100 may be performed in “real-time” to initiate, prepare, and/or populate a mass spectral library, or alternatively may be conducted as a post-processing protocol on an existing mass spectrum library.

In step 102, an experimentally derived mass spectrum of a compound of interest is obtained. In one embodiment, the mass spectrum is obtained from an accurate mass MS/MS spectrometer. As used herein, to “obtain an experimentally derived mass spectrum” is intended to broadly include the acts of conducting a spectral analysis, receiving an experimentally derived mass spectrum directly from a spectrometer instrument, and/or receiving (push or pull) a mass spectrum from an existing library. Step 102 may further include conducting known pre-processing algorithms on the experimentally derived mass spectrum. For example, in one embodiment, step 102 further includes conducting a background subtraction algorithm on the experimentally derived mass spectrum.

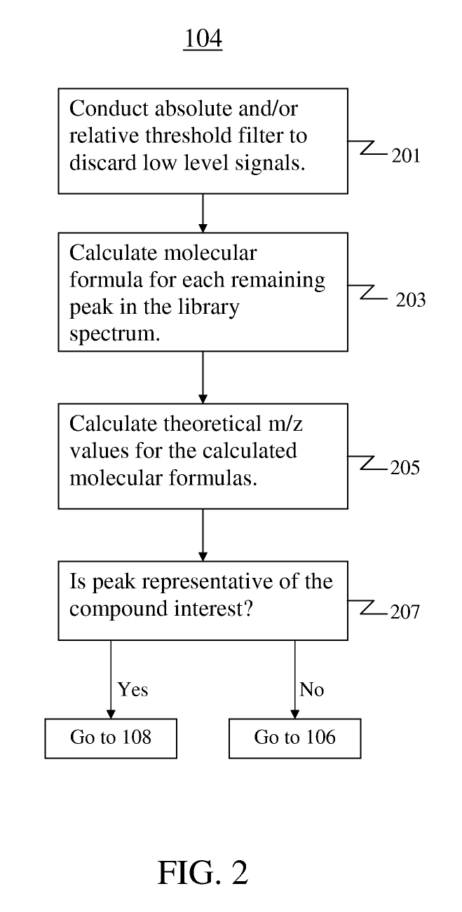

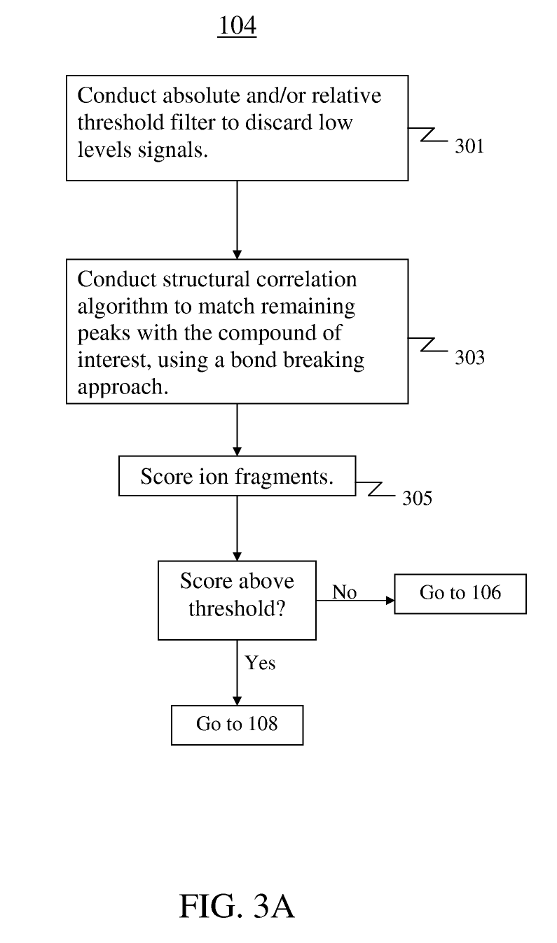

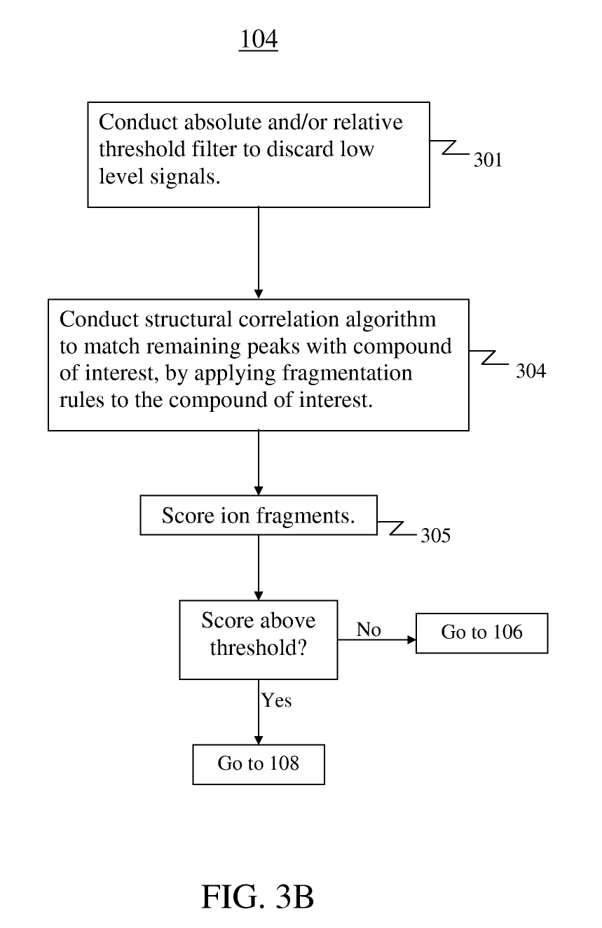

In step 104, peaks that correspond to the compound of interest are identified. FIGS. 2, 3A, and 3B, discussed below, provide alternative embodiments for identifying peaks corresponding to the compound of interest. The sub-protocols described in FIGS. 2, 3A, and 3B may be employed collectively in serial or parallel, or may be employed individually. After the peaks corresponding to the compound of interest have been identified, any and/or all peaks that do not correspond to the compound of interest are removed from the spectrum in step 106. As used herein, the term “any” is intended to mean “one, a, an, or some; or whatever it may be; or whichever it may be.” The term “any” may, but does not necessarily mean “all.” The removal of any non-corresponding peaks increases the specificity of the spectrum.

In step 108, the experimental m/z value for each remaining peak is replaced with a calculated theoretical m/z value for the respective peak. By replacing the experimentally derived m/z value with a theoretical m/z value, the instrumentation error is minimized and future searches of unknown compounds against the curated spectrum can be conducted with tighter tolerances and more specificity.

FIG. 2 is a flowchart illustrating a sub-protocol for the identifying step 104 of FIG. 1, in accordance with one embodiment presented herein. The sub-protocol 104 of FIG. 2 employs a molecular formula generation (MFG) algorithm to identify which peaks in an experimental (i.e., experimentally measured) library spectrum corresponding to the compound of interest.

In step 201, the library spectrum is subjected to an absolute and/or relative threshold filter to discard low level peaks. Step 201 is an optional step, and in an alternative embodiment may be conducted as part of step 106. Algorithms for conducting absolute and/or relative threshold filters are known in the art.

In step 203, a molecular formula is calculated for each remaining peak in the spectrum using an MFG algorithm. MFG algorithms are known in the art. For example, Darland, et al., “Superior Molecular Formula Generation from Accurate-Mass Data,” Technical Overview, published by Agilent Technologies, Jan. 4, 2008, which is incorporated by reference herein in its entirety, provides a description of an MFG algorithm. In one embodiment, the calculation of a molecular formula for an unknown compound measured with mass spectrometry is done by adding up the masses of different elements and permutating through different numbers of the allowed elements, such that the resulting mass falls within the mass windows defined by the measured mass and the mass accuracy of the used mass spectrometer. Exact calculations take into account the mass of an electron. In order to further increase the confidence in a calculated molecular formula, the theoretical isotope pattern of a calculated molecular formula is compared to the experimental isotopic pattern, using both the relative abundances and the spacing of the isotopes. Additional discrimination can be achieved by also using the accurate measured mass of fragment ions and the neutral differences between the precursor ion and each fragment ion. The calculated molecular formulas for each fragment ion and it's corresponding neutral difference must add up to the proposed formula of a precursor ion.

In step 205, the MFG algorithm is also used to calculate theoretical m/z values of isotopes by permutating through possible combinations of allowed elements and comparing the resulting m/z value with the experimental m/z value. The MFG algorithm may take the mass difference between the theoretical and the experimental m/z values into account. Additional chemical rules can be applied to exclude formulas which do not make chemical sense.

In step 207, a determination is made as to whether the peak is representative of the compound of interest. Peaks that are representative of the compound of interest are kept in the library spectrum; the process continuing to step 108. Peaks that are not representative of the compound of interest are removed from the spectrum, in step 106. For example, for each peak in the spectrum, the MFG algorithm calculates a list of possible sub-formulas based on the parent formula given to the algorithm. If the MFG algorithm does not come up with any sub-formula for the peak, then there is no sub-formula that can be derived from the parent formula within a given mass tolerance (˜10 ppm) for that peak. The peak is therefore deemed to be not explainable and not originate from the compound of interest. The peak is therefore removed from the spectrum. If the MFG is able to generate one or more sub-formulas for the peak, the peak is then kept and corrected to the m/z value (step 108) of the sub-formula that has the least distance from the experimental peak.

FIG. 3A is a flowchart illustrating another sub-protocol for the identifying step 104 of FIG. 1, in accordance with another embodiment presented herein. The sub-protocol 104 of FIG. 3A employs a structural correlation (MSC) algorithm to identify which peaks in an experimental library spectrum corresponding to the compound of interest.

In step 301, the library spectrum is subjected to an absolute and/or relative threshold filter to discard low level peaks. Step 301 is an optional step, and in an alternative embodiment may be conducted as part of step 106. Algorithms for conducting absolute and/or relative threshold filters are known in the art.

In step 303, the MSC algorithm uses a systematic bond breaking approach to try to match the peaks in the spectrum with the compound of interest. MSC algorithms employing bond breaking approaches are known to the art; e.g. Hill and Mortishire-Smith, Rapid Commun Mass Spectrom. 2005; 19:3111-3118, which is incorporated herein by reference in its entirety. In step 305, for each ion fragment, a score is calculated which can include, but is not limited to: an accuracy of the experimental m/z value; a number of bond breakages necessary to form the ion fragment; a type of bond which needs to be broken; a rearrangement of hydrogens necessary for the ion fragment; and any combination thereof. The MSC algorithm also calculates the formula for each ion fragment that fulfills the scoring criteria. Each ion fragment that has a score above a certain threshold, is deemed to originate from the compound of interest and is kept in the library spectrum. All other ion fragments are discarded, in step 106. For each peak which is deemed to belong to the library compound, the experimental m/z value is replaced with the theoretical m/z value calculated for the calculated sub-formula, in step 108.

FIG. 3B is a flowchart illustrating an alternative sub-protocol for the identifying step 104 of FIG. 1, in accordance with yet another embodiment presented herein. The sub-protocol 104 of FIG. 3B employs an alternative structural correlation (MSC) algorithm to identify which peaks in an experimental library compound spectrum belong to the compound of interest. The sub-protocol of FIG. 3B is similar to the sub-protocol of FIG. 3A, except that step 303 is replaced with step 304, as discussed below.

In step 301, the library spectrum is subjected to an absolute and/or relative threshold filter to discard low level peaks. Step 301 is an optional step, and in an alternative embodiment may be conducted as part of step 106. Algorithms for conducting absolute and/or relative threshold filters are known in the art.

In step 304, the MSC algorithm applies a set of fragmentation rules to the known structure of the compound of interest, and predicts which fragment ions might be formed based on the chemical structure. Multiple fragmentations of a molecule can be considered, which results in a fragmentation pathway. Such MSC algorithms are known to the art and have been productized by, for example, ACD Labs (MS Fragmenter) and Mass Frontier. Such algorithms then compare the experimentally found fragment ions with the predicted fragment ions. In step 305, a score is calculated based on the accuracy of the experimental m/z value compared to the theoretical m/z value for each predicted fragment ion. Each experimental fragment ion which has a score above a certain threshold is deemed to originate from the compound structure of interest and is kept in the spectrum; all other ion fragments are discarded, in step 106. Since the output of such algorithms includes the substructure and formula of the predicted fragment ions, the experimental m/z can then be corrected to the theoretical m/z values for the library spectrum, in step 108.

The presented methods, or any part(s) or function(s) thereof, may be implemented using hardware, software, or a combination thereof, and may be implemented in one or more computer systems or other processing systems. Further, the presented methods may be implemented with the use of one or more accurate mass spectrometers, TOFs, traps, quadrupole, orbitrap-type, FT, or magnetic sector instruments. Where the presented methods refer to manipulations that are commonly associated with mental operations, such as, for example, curating, obtaining, calculating, correcting, or conducting, no such capability of a human operator is necessary. In other words, any and all of the operations described herein may be machine operations. Useful machines for performing the operation of the methods include general purpose digital computers or similar devices.

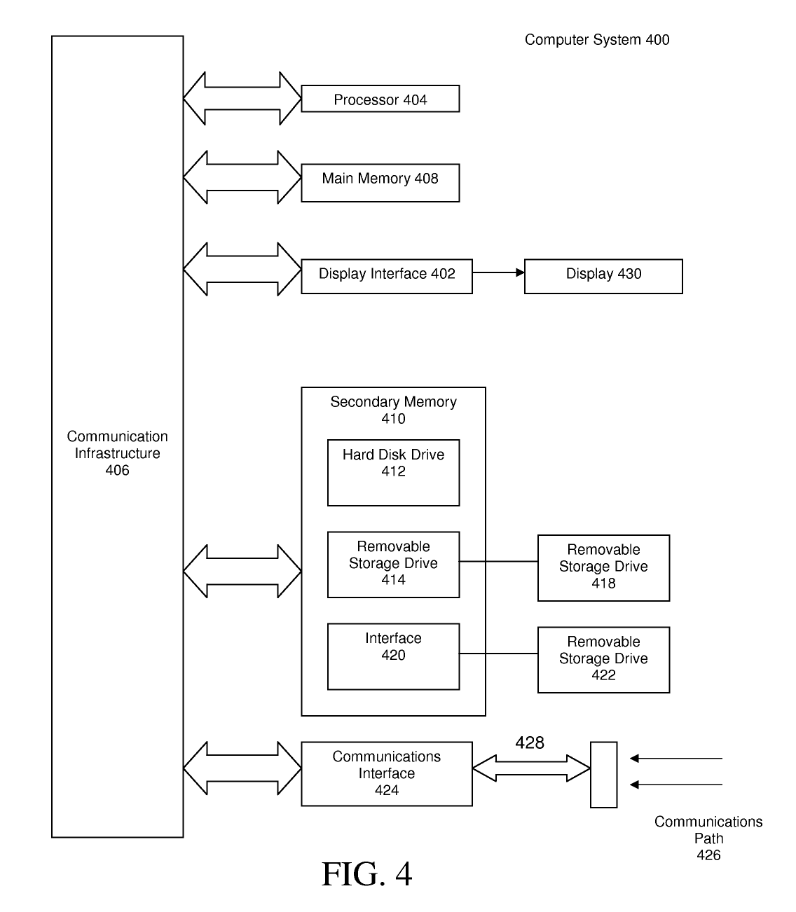

In fact, in one embodiment, the invention is directed toward one or more computer systems capable of carrying out the functionality described herein. An example of a computer system 400 is shown in FIG. 4. Computer system 400 includes one or more processors, such as processor 404. The processor 404 is connected to a communication infrastructure 406 (e.g., a communications bus, cross-over bar, or network). Computer system 400 can include a display interface 402 that forwards graphics, text, and other data from the communication infrastructure 406 (or from a frame buffer not shown) for display on a local or remote display unit 430.

Computer system 400 also includes a main memory 408, such as random access memory (RAM), and may also include a secondary memory 410. The secondary memory 410 may include, for example, a hard disk drive 412 and/or a removable storage drive 414, representing a floppy disk drive, a magnetic tape drive, an optical disk drive, flash memory device, etc. The removable storage drive 414 reads from and/or writes to a removable storage unit 418 in a well known manner. Removable storage unit 418 represents a floppy disk, magnetic tape, optical disk, flash memory device, etc., which is read by and written to by removable storage drive 414. As will be appreciated, the removable storage unit 418 includes a computer usable storage medium having stored therein computer software and/or data.

In alternative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 414, removable storage units 418, 422, data transmitted via communications interface 424, and/or a hard disk installed in hard disk drive 412. These computer program products provide software to computer system 400. Embodiments of the present invention are directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 404 to perform the features of the presented methods. Accordingly, such computer programs represent controllers of the computer system 400. Where appropriate, the processor 404, associated components, and equivalent systems and sub-systems thus serve as “means for” performing selected operations and functions.

In an embodiment where the invention is implemented using software, the software may be stored in a computer program product and loaded into computer system 400 using removable storage drive 414, interface 420, hard drive 412, or communications interface 424. The control logic (software), when executed by the processor 404, causes the processor 404 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed, to the extent that such combinations embrace operable processes and/or devices/systems/kits.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A method of curating a mass spectral library, comprising
(a) obtaining an experimentally derived mass spectrum of a compound of interest;
(b) identifying a peak in the mass spectrum that represent an experimental m/z value for an ion fragment of the compound of interest;
(c) removing from the mass spectrum any peak that does not correspond to the compound of interest; and
(d) replacing the experimental m/z value for the peak identified in step (b) with a calculated theoretical m/z value for the ion fragment.

2. The method of claim 1, wherein the experimentally derived mass spectrum has a mass precision of 10 ppm or less.

3. The method of claim 1, wherein step (b) further comprises:
obtaining either a molecular formula or structure for the compound of interest.

4. The method of claim 1, wherein step (b) further comprises:
conducting a molecular formula generation algorithm for a peak in the mass spectrum.

5. The method of claim 4, wherein step (b) further comprises:
identifying the theoretical m/z value for the ion fragment based on the molecular formula generation algorithm.

6. The method of claim 1, wherein step (b) further comprises:
conducting a structural correlation algorithm for a peak in the mass spectrum.

7. The method of claim 6, wherein step (b) further comprises:
scoring the peak based on factors selected for the group consisting of: an accuracy of the experimental m/z value, a number of bond breakages necessary to form the ion fragment, a type of bond which needs to be broken, a rearrangement of hydrogens necessary for the ion fragment, and any combination thereof.

8. The method of claim 1, wherein step (b) further comprises:
conducting a structural correlation algorithm for a peak in the mass spectrum, wherein the structural correlation algorithm includes a fragmentation analysis.

9. The method of claim 8, wherein step (b) further comprises:
scoring the peak based on the fragmentation analysis.

10. A computer-readable storage medium for curating a mass spectral library, comprising:
instructions executable by at least one processing device that, when executed, cause the processing device to
(a) obtain an experimentally derived mass spectrum of a compound of interest;
(b) identify a peak in the mass spectrum that represent an experimental m/z value for an ion fragment of the compound of interest;
(c) remove from the mass spectrum any peak that does not correspond to the compound of interest; and
(d) replace the experimental m/z value for the peak identified in step (b) with a calculated theoretical m/z value for the ion fragment.

11. The computer-readable storage medium of claim 10, wherein the instructions further cause the processing device to conduct a threshold filter of low level peaks in the mass spectrum, prior to step (b).

12. The computer-readable storage medium of claim 10, wherein the instructions further cause the processing device to obtain either a molecular formula or structure for the compound of interest.

13. The computer-readable storage medium of claim 10, wherein the instructions further cause the processing device to conduct a molecular formula generation algorithm for a peak in the mass spectrum.

14. The computer-readable storage medium of claim 11, wherein the instructions further cause the processing device to identify the theoretical m/z value for the ion fragment based on the molecular formula generation algorithm.

15. The computer-readable storage medium of claim 10, wherein the instructions further cause the processing device to conduct a structural correlation algorithm for a peak in the mass spectrum.

16. The computer-readable storage medium of claim 15, wherein the instructions further cause the processing device to score the peak based on factors selected for the group consisting of: an accuracy of the experimental m/z value, a number of bond breakages necessary to form the ion fragment, a type of bond which needs to be broken, a rearrangement of hydrogens necessary for the ion fragment, and any combination thereof.

17. The computer-readable storage medium of claim 10, wherein the instructions further cause the processing device to conduct a structural correlation algorithm for a peak in the mass spectrum, wherein the structural correlation algorithm includes a fragmentation analysis.

18. The computer-readable storage medium of claim 17, wherein the instructions further cause the processing device to score the peak based on the fragmentation analysis.

19. A mass spectrometer system comprising the computer-readable storage medium of claim 10.

20. A method of curating a mass spectral library, comprising
(a) obtaining an experimentally derived mass spectrum of a compound of interest, wherein the mass spectrum has a mass precision of 10 ppm or less;
(b) using a molecular formula generation algorithm or a structural correlation algorithm to obtain either a molecular formula or structure for the compound of interest;
(c) identifying a peak in the mass spectrum that represent an experimental m/z value for an ion fragment of the compound of interest based on step (b);
(d) removing from the mass spectrum any peak that does not correspond to the compound of interest;
(e) replacing the experimental m/z value for the peak identified in step (c) with a calculated theoretical m/z value for the ion fragment; and
(f) saving the mass spectrum to the mass spectral library.
